(19) United States
(12) Patent Application Publication
(10) Pub. No.: US 2010/0324943 A1
(43) Pub. Date: Dec. 23, 2010

(54) GENETICALLY PREDICTED LIFE EXPECTANCY AND LIFE INSURANCE EVALUATION

(75) Inventor: Marc S. Klibanow, Riverwoods, IL (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: GENOWLEDGE LLC, Las Vegas, NV (US)

(21) Appl. No.: 12/488,294

(22) Filed: Jun. 19, 2009

(51) Int. Cl. G06Q 40/00; G06F 17/30; G06F 19/00

(52) U.S. Cl. 705/4; 707/802; 702/19; 707/E17.044

(57) ABSTRACT

The present invention provides a system and methods for using a central database apparatus to evaluate a life insurance policy for a member of a population based on the genetically predicted life expectancy of the member.

### BACKGROUND OF THE INVENTION

Traditionally, the life insurance market offered limited alternatives to a policyholder who wanted to dispose of their current policies. The policy owner would generally surrender the policy and receive the cash as listed in the nonforfeiture values of the policy or let the policy lapse and receive additional insurance coverage in the form of additional term insurance, for as long as the cash values permitted. These nonforfeiture values are minimal at best. Prior to standard nonforfeiture laws which now provide for the computation of minimum values, lapses resulted in the insured individual receiving nothing at all. This classic insurance market form is a monopsony with the market dynamics of one buyer, the insurance company, facing many sellers, the policyholders, resulting in considerable pricing power for the insurance companies. This condition is similar to a monopoly, in which only one seller faces many buyers. The incumbent insurers have monopsony pricing over insured individuals. However, the intrinsic value of a life insurance policy always exceeds the cash surrender value offered to the insured. Because of these market dynamics, a secondary market has evolved, referred to as the Life Settlement Market.

In the Life Settlement Market, a third party bidder purchases the policy from the policyholder and becomes the successor owner, with all the same property rights as the original policy owner. The third party owners generally are willing to pay far more to the original policy owner than the monopsony insurance carrier. The secondary insurance marketplace, however, is extremely inefficient in valuing policy transactions. The successor owners are financial buyers who are paying the original owner more than other bidders and receiving the policies death benefits as a financial return.

It is useful to understand the role of the participants in the policy transaction process. The insured individual is the person whose life is covered by the policy being considered and is usually the initial policy owner. Usually, the insured individual is the policy seller in the transaction, although after the initial settlement transaction the seller could then be any successive policy owner. An advisor, such as financial advisors or insurance agents, typically acts as a consultant to advise the seller about the alternatives available. The bids generated for life insurance policies can be referred to as life settlement bids. A broker is the person responsible for shopping for bids, soliciting multiple bidders, and preferably works with four to five bidders, known as life settlement providers. A life settlement provider is the entity who formulates the bid to purchase and conveys that bid to the brokers. The life settlement providers can either purchase policies for their own accounts or for eventual downstream economic investors. A life expectancy provider is the specialized service company that reviews the medical records, in order to provides underwriting estimates of the insured's life expectancy to the life settlement provider for bid formulation. Investors generally fund the life settlement providers (e.g., through hedge funds, investment banks). In some cases, investors can originate their own in-house provider. Sometimes the investors may be trusts that issue bonds (to bondholders) as a form of derivative securities. These bonds fund the policy acquisitions and are repaid through the settlement of the policies acquired.

Initially, the policy owner or client can consult with an advisor in order to decide whether to sell his or her policy. The client and advisor can work together to decide if a broker will be brought into the transaction or if they will go directly to the providers. The client and advisor can submit the policy for valuation and the policy owner releases medical information. The life settlement providers then order a life expectancy report from the life expectancy providers in order to access the risk in a proposed transaction. That report will look at the medical history of the insured to see if the policy meets the criteria for bid. If the policy meets criteria for a life settlement, the provider can then send offers directly to the client or send offers to the client through a broker. Some examples of criteria for a life settlement are: 1) if the insured person has a limited life expectancy due to advanced age or medical impairments, 2) the policy is transferable and has been in effect for a period of time beyond the contestability period, 3) the policy is issued by a U.S. insurance company, and 4) a death benefit of no less than $50,000 is associated with the policy. At this point, the client and advisor can review the offers and the client can accept a preferred offer. The client and advisor can complete the provider's closing package and return the essential documents. The provider can place the cash payment for the policy in escrow and submit change of ownership forms to the insurance carrier. The paperwork can be verified and funds transferred to the policy seller.

Any type of life insurance policy can be purchased in a transaction, such as universal life, term life, whole life or survivorship life. The selling policy owner can be one or more individuals, a trust, a corporation or non-profit organization, a bank or other financial institution, a limited liability company, partnership or other business entity. The face value of an insurance policy provides a maximum value from which the cash surrender value is determined. For an individual of normal health, a survival curve is generated by analysis of age versus policy value, wherein the start point is at the age of policy purchase and the end point is predicted by the estimated life expectancy for an individual of ‘normal health’ and lies at predicted age of fatality, wherein the economic value of the policy equals the actual face value of the policy. This survival curve provides a graphical representation of the economic value of the insurance policy to the secondary insurance market. The additional knowledge of an individual's medical conditions allows for greater accuracy in predicting life expectancy, but to date general applications have been based only on medical records and family history. In reviewing medical records, the value of an individual's policy to the secondary marketplace may lie at a point outside of the ‘normal health’ survival curve if that individual is in superior health or poor health.

The cash surrender value of a life insurance policy is determined at issue and is based on fully underwritten, standard mortality data. These values are set and do not change when the policy holder's health status changes. The life settlements value is determined at time of settlement and is based on possible impaired mortality at settlement, the life expectancy, as estimate by the life expectancy provider, and the successor financial buyers required rate of return, time horizon and risk tolerance. These values are set by life settlement companies and vary depending on the level of impairment of the policy holder. The insured's life expectancy is crucial for the formation of a life settlement company bid. To date, these life settlement bids are based on conventional life underwriting and utilize medical records.

The traditional valuation of life insurance policies has no predictive value and, as discussed above, is reliant on historical information (e.g., medical records, family medical history, and lifestyle habits). The methods disclosed herein consider underlying reasons affecting life expectancy not currently factored in for policy buyers, sellers and investors. There is a market and a need for improved life insurance policy valuation accuracy.

The sequencing of the human genome has led to insights into the genetic bases of human disease and mortality, both important factors of life expectancy. It has also given rise to a better understanding of underlying genomic causes of the differences that arise between people in response to their environments. Several genomic changes (such as copy number variations) and small scale structural changes (such as inversions and deletions) have been implicated in the pathology of disease. For example, single nucleotide changes in specific positions in the human genome known as Single Nucleotide Polymorphisms (SNPs), have an effect on the observed phenotypic differences between individuals. Differences in SNPs can affect how susceptible individuals are to environmental factors, such as smoking, and how likely they are to respond to medical interventions. SNPs are one of the factors that effect the genetic predisposition of an individual to develop a certain disease and can also be predictive of an individual's mortality from a disease.

Recent advances in high-speed genotyping technology have allowed the scientific community to make progress in identifying and validating many common genetic polymorphisms that are associated with risk of disease.

Since 1977, the Sanger method has been the chosen method for DNA sequencing studies, including the Human Genome Project. In recent years however, there has been a number of sequencing technologies that no longer rely on the Sanger method and show improvements in the fundamental sequencing areas of read length, throughput, and cost (Chan. 2005. Mutation Research. 573:12-40; Lander et al. 2001. Nature 409:860-921; Shaffer. 2007. Nature Biotechnology 25(2):149; Nature Methods. January 2008. 5(1)). Examples of these techniques include: pyrosequencing technology of 454 Life Sciences; polymerase-colony technology developed by Solexa, Inc. and currently owned and marketed by Illumina, Inc.; and sequencing by ligation, developed by Agencourt Bioscience Corp., which now forms the basis for Applied Biosystems' SoLID System sequencers; and single molecule sequencing, such as that developed and marketed by Helicos Biosciences.

As compared to the cost of the Human Genome Project, the above technologies can sequence a human's genome for much less. Technologies (such as those offered by Helicos Biosciences, Pacific Biosciences, and Oxford Nanopore Technologies) have demonstrated the capacity to further reduce this cost.

SNP arrays can be used to profile several hundred thousand to a million SNP markers for a given individual at a reasonable cost. These arrays are used to study genetic variation across the entire genome. A personal genetics company, 23andMe, unveiled an array that will genotype almost 600,000 SNPs for $399. Sequencing costs are reducing dramatically every year, decreasing the cost of sequencing the genome.

Several approaches have been proposed to characterize the contribution of genetics to disease susceptibility and longevity or lifespan. Kenedy et al., (2008/0228818), incorporated in its entirety herein by reference, discusses a bioinformatics method, software, database and system in which attribute profiles of query-attribute-positive individuals and query-attribute-negative individuals are compared. See also U.S. Patent Application Nos. 2008/0076120, 2007/0259351, 2007/0042369, 2008/0228772, 2008/0187483, 2003/0040002, 2006/0068432, 2008/0131887, 2008/0195327, U.S. Pat. Nos. 7,406,453 and 6,653,073, International Publication No. WO 2004/048591, WO 2004/050898, WO 2006/138696, WO 2006121558, WO 2007127490. These sources do not account for the ability to prepare a meta-analysis of the available data across a multitude of genes and gene variants and correlate this collective data to determine a life expectancy as related to life insurance policy evaluation.

The genetic contribution to life expectancy is multiplicative on the risk scale, as expected from the significant number of inheritable traits passed from generation to generation (Risch. 2001. Cancer Epidemiology Biomarkers & Prevention. 10:733-741). However, the ability to detect interactions among risk alleles is limited due to the sample sizes of current epidemiological studies. Therefore, the present invention provides a novel approach to integrating the data from epidemiological studies in a useful manner as related to the personalized prediction of genetic risk and the personalized prediction of life expectancy. This approach is demonstrated in embodiments of the current invention.

### SUMMARY OF THE INVENTION

The present invention provides a method for using a central database apparatus to evaluate a life insurance policy for a member of a population. The central database apparatus contains a genetic database and a life expectancy database. The method of policy evaluation comprises: a) identifying at least one candidate gene; b) using a retrieval apparatus adapted to retrieve literature to collect literature containing risk data relating to the candidate gene and life expectancy data; d) uploading the risk data from the collected literature into the genetic database; e) uploading the life expectancy data from the collected literature into the life expectancy database; g) using a computer to calculate a collective risk index based on the uploaded risk data and the uploaded life expectancy data; h) collecting input data from the population member; i) using the collected input data and the calculated collective risk index to determine a genetically predicted life expectancy (GPLE) for the member; and j) evaluating the life insurance policy based on the GPLE.

In another embodiment, the present invention provides a method for evaluating life insurance policy premium levels for a population in a central database apparatus, comprising a) identifying at least one candidate gene; b) using a retrieval apparatus adapted to retrieve literature to collect literature containing risk data relating to the candidate gene and life expectancy data; d) uploading the risk data from the collected literature into the genetic database; e) uploading the life expectancy data from the collected literature into the life expectancy database; g) using a computer to calculate a collective risk index based on the uploaded risk data and the uploaded life expectancy data; h) collecting input data from the population member; i) using the collected input data and the calculated collective risk index to determine a GPLE for the member; and j) evaluating the life insurance policy premium value based on the GPLE.

The present invention also provides for a system for evaluating a life insurance policy for a member of a population. In this embodiment, the system includes a computer server and a central database apparatus, with the central database apparatus including a genetic database and a life expectancy database, and the server being configured to: a) prompt a user to identify at least one candidate gene; b) prompt the user to collect literature containing risk data relating to the at least one candidate gene and life expectancy data; c) upload the risk data from the collected literature into the genetic database; d) upload the life expectancy data from the collected literature into the life expectancy database; e) calculate a collective risk index based on the uploaded risk data and the uploaded life expectancy data; f) prompt the user to provide input data relating to the population member; g) use the provided input data and the calculated collective risk index to determine a GPLE for the member; and h) evaluate the life insurance policy based on the determined GPLE.

In another embodiment, input data includes a biological sample collected from the member. In this embodiment, the biological sample contains genomic DNA.

In another embodiment, a genomic DNA sequence is isolated from the biological sample of the member. In yet another embodiment, a candidate gene is contained in the genomic DNA sequence isolated.

The present invention further provides a method for using an individual's genomic profile to evaluate his or her life insurance policy by 1) obtaining a biological sample from the individual, 2) determining the genomic sequence from the biological sample, 3) correlating the genomic sequence to the central database containing genetic risk data and life expectancy data, 4) calculating a GPLE for the individual and 5) evaluating the life insurance policy for the individual based on the GPLE or determining premium levels for a life insurance policy for the individual based on the GPLE.

In a further embodiment, the life insurance policy is categorized based on the GPLE.

In even further embodiments of the present invention, additional factors can be used to evaluate life insurance policy value, such as genetic markers, medical history, personal habits, exercise habits, dietary habits, health habits, social habits, occupational exposure, environmental exposure and the like. In one embodiment, the genetic markers can be selected from DNA point mutations, DNA frame-shift mutations, DNA deletions, DNA insertions, DNA inversions, DNA expression mutations, DNA chemical modifications and the like. In a further embodiment, the genetic markers can be single nucleotide polymorphisms (SNPs).

In another embodiment, the medical history includes information related to a manifested disease, a disorder, a pathological condition and/or a genomic DNA sequence.

In another embodiment of the present invention, the collective risk index can be relative risk, hazard ratio or an odds ratio. In a preferred embodiment, the collective risk index is a meta-analysis odds ratio.

In still another embodiment, the central database apparatus is iteratively updated with additional risk data and life expectancy data.

### BRIEF DESCRIPTION OF THE DRAWINGS

FIG. 1 is an example of a display window interface for searching literature in a database.

FIG. 2 is an example of a display window interface for searching abstracts in a database.

FIG. 3 is a flow chart illustrating aspects of the methods herein.

FIG. 4 is an example of data fields related to candidate genes and disease.

FIG. 5 is a flow chart illustrating aspects of the methods herein.

FIG. 6 is a flow chart illustrating aspects of the methods herein.

FIG. 7 is an example of a calculated survival curve related to Example 4.

### DETAILED DESCRIPTION

Disclosed herein are methods, computer systems, and databases for evaluating and appraising life insurance policies for a population based on factors such as genetic information, medical history, personal habits, exercise habits, dietary habits, health habits, and social habits. Disclosed herein are databases, as well as systems for creating and accessing databases, describing these factors for populations and for performing analyses based on these factors. The methods, computer systems, and software can be useful for identifying complex combinations of factors that can be correlated with life expectancy calculations and survival predictions. The methods, computer systems, databases can also be used to analyze the value of life insurance policies based on the presence of these factors and their influence on the calculated life expectancy and survival rates. The methods, computer systems, and databases can also be used to determine the market value of life insurance policies for the secondary insurance marketplace.

The present invention provides improved methods for evaluating life insurance policies. More specifically, the present invention provides novel methods for incorporating genetic information into the determination of life expectancy and economic or market insurance policy value. This genetic information provides direct benefits by allowing policy purchasers to access new market segments. Currently, the methods available evaluate the policy of the medically impaired individual, based on medical and family history and by using life expectancy tables. Using the methods of the present invention, life insurance policies for individuals possessing altered genetic information in candidate genes or those genes associated with enhanced or diminished life expectancy become valuable assets. Furthermore, the novel methods herein provide for direct advantages and improvements over the methods of the prior art in that they identify a population of individuals that would otherwise be overlooked in the secondary insurance market (e.g., otherwise healthy individuals with high risk genetic mutations).

The arrival of more comprehensive and cheaper SNP arrays in the near future will enable rapid genotyping of individuals across the economic spectrum. As such, models that integrate findings from latest genetic association studies to predict risk of disease and mortality will become very important. Therefore, with increasing understanding of the genetic causes of complex polygenic diseases, an embodiment of the present invention demonstrates the ability to predict disease risk, GPLE and life insurance policy valuation factoring in the presence of specific genetic markers.

These genetic markers can be any genome, genotype, haplotype, chromatin, chromosome, chromosome locus, chromosomal material, deoxyribonucleic acid (DNA), allele, gene, gene cluster, gene locus, gene polymorphism, gene mutation, gene marker, nucleotide, single nucleotide polymorphism (SNP), restriction fragment length polymorphism (RFLP), variable number tandem repeat (VNTR), copy number variation (CNV), sequence marker, sequence tagges site (STS), plasmid, transcription unit, transcription product, ribonucleic acid (RNA), micro RNA, copy DNA (cDNA), and DNA sequence containing point mutations, frame-shift mutations, deletions, insertions, inversions, expression mutations and chemical modifications (e.g., DNA methylation) or the like. Genetic markers include the nucleotide sequence and, as applicable, encoded amino acid sequence of any of the above or any other genetic marker known to one of ordinary skill in the art.

Embodiments of the present invention provide methods to determine GPLE related to life insurance policy value using genetic associations for disease susceptibility and longevity. The present invention also provides methods for identifying the contribution of genetic information to the prediction of one's medical health and life expectancy and the effect of genetic information on survival curves used to valuate life insurance policies.

The present invention provides a method to determine GPLE from three perspectives: 1) identification of genetic information or gene/disease associations and the use of the associated odds ratios (ORs) to construct modified survival curves for the given genotype population; 2) identification of candidate genes involved in human lifespan (longevity) determination or life expectancy probabilities and the use of variations at the associated genetic loci to calculate positive or negative shifts in life expectancy probabilities; 3) identification of shifts in life expectancy probabilities to valuate life insurance policies.

Although applicable to any gene, the preferred candidate genes of the present invention can be those involved in disease, aging-related diseases, and genes involved in genome maintenance and repair. Aging is a complex biological phenomenon, likely to be controlled by multiple mechanisms and processes, genetic and epigenetic. Through the combined interaction and interdependence of biological systems, the survival or life span of an organism can be determined. The role of genes on survival or life span has been studied in twins, human genetic mutants of pre-mature aging, genetic linkage studies for the inheritance of lifespan and studies on genetic markers of exceptional longevity. Genes involved in the aging process such as longevity-assurance genes, longevity-associated genes, vitagenes and gerontogenes are examples of candidate genes. Longevity assurance genes can be variants (or alleles) of certain genes that allow an organism to live longer. Mutations in these genes can alter the slope of age dependent mortality curves. Without being limited to any theory, some gerontogenes may decrease life span by blocking expression of longevity-assurance genes.

Genome-wide association studies (GWAS) show that the majority of genetic variants in the population confer only a small increased risk to disease (Wray et al. 2007. Genome Research. 17(10):1520-1528; Wray et al. 2008. Current Opinion in Genetics and Development. 18:1-7; Wellcome Trust Case Control Consortium. 2007. Nature 447(7145):661-78). Wray et al. 2007, Wray et al. 2008 and Wellcome Trust Case Control Consortium 2007 are incorporated in their entirety by reference. This risk is reflected in the numerical ORs, typically an OR of less than 1.5 is observed, with many ORs around 1.1 to 1.2, with a neutral effect for a genetic variant having an odds ratio equal to 1. Genetic variants exhibiting more significant effects on risk to disease typically possess odds ratios greater than 2.

A simulation of GWAS by Wray et al. shows that, for a case-control study with 10,000 cases and controls, it will be possible to identify the larger loci (˜75) that explain >50% of the genetic variance in the population (Wray et al. 2007. Genome Research. 17(10):1520-1528). In addition, a high percentage of the genetic risk can be predicted by pooling data, even when mutations with relatively low ORs form the basis for that prediction. For example, Wray et al. identified a correlation>0.7 between predicted and true genetic risk (explaining >50% of the genetic variance) even for diseases controlled by 1,000 loci with mean relative risk of only 1.04.

There are many advantages provided by the methods of the present invention. First, the statistical power of the genetic association data can be increased by pooling results using embodiments of the present invention from multiple GWAS, which, in turn, can help the identification of many more risk variants with small effect sizes. Also, these risk variants can be used to explain a larger percentage of genetic variance.

Second, optimal statistical methods can be employed for selecting and combining multiple genetic risks (such as SNPs) into a risk prediction equation. This is a common challenge to most studies of genomics because the number of measured variables is much greater than the number of samples. In this invention, several machine learning techniques, such as support vector machines and random decision forests, can be applied to microarray gene expression data to improve diagnosis and risk stratification in clinical studies. These methods and a number of other methods that have been applied to SNP selection can be useful in constructing a risk prediction equation.

Embodiments of the present invention provide for the integration of data from a wide range of genetic association studies to effectively improve prediction probability of contracting a certain disease (e.g., relative risk, odds ratio, hazard ratio and the like) and mortality from that disease for an individual given his/her genomic profile. In certain embodiments, an individual's genomic profile can be combined with additional medical and demographic information to further improve prediction probability. Furthermore, life expectancy predictions generated by embodiments of the invention can be used to evaluate life insurance policies held by these individuals.

The present invention provides a method by which genetic susceptibility risk data can be curated from literature and compiled into a central database apparatus. Risk data can be data containing statistical contributions of genetic attributes related to disease (e.g., relative risk, odds ratios, hazard ratios, p-values or the like). In the first phase of data collection (primary curation), studies that have been performed on a large number of subjects such as meta-analysis, pooled analysis, review articles and genome-wide association studies (GWAS) can be included. The present invention provides for subsequent rounds of data collection and curation. Later phases of data collection (e.g., secondary curation and final curation) can use smaller scale genetic association studies to refine these results. A method according to this invention is outlined below:

identifying high mortality diseases and their relevant genetic associations (candidate genes);

searching, retrieving and filtering of relevant literature;

curating data from literature;

depositing relevant data into the central database apparatus;

building a statistical framework to integrate the data;

receiving input data (e.g., genomic profile of candidate genes);

calculating a disease susceptibility or fatality score, and a GPLE based on the individual's genetic profile (genomic sequence); and

correlating the GPLE score to a predicted life insurance policy value or premium level.

Identifying High Mortality Diseases and their Relevant Genetic Associations

Specific high fatality diseases have been identified based on a survey of mortality data from various public resources. Upon identification of a particular disease, all genetic and environmental associations of interest can be explored by scientific teams of individuals designated to review the identified literature (e.g., the scientific team comprises a project manager, primary curator, secondary curator and database manager). The list of associations can be reviewed and amended on a continual basis resulting in a continually expanding list, both in terms of the number of diseases included and the number of candidate genes (genetic determinants) with an established effect on the mortality rates of those diseases already listed and under investigation.

Exemplary diseases addressed by the methods of the present invention include: adenomatous polyposis coli, Alzheimer's disease, amyotrophic lateral sclerosis, brain neoplasm, chronic bronchitis, carcinoma, endometrioid carcinoma, hepatocellular carcinoma, non-small-cell lung carcinoma, pancreatic ductal carcinoma, renal cell carcinoma, small cell carcinoma, carotid artery thrombosis, cerebral infarction, cerebrovascular disorders, cervical intraepithelial neoplasia, colonic neoplasms, colorectal neoplasms, coronary thrombosis, Creutzfeldt-Jakob syndrome, Denys-Drash syndrome, type 2 diabetes mellitus, diabetic nephropathy, paradoxical embolism, esophageal neoplasms, Gardner's syndrome, gastric neoplasms, head and neck neoplasms, hepatic vein thrombosis, hereditary nonpolyposis colorectal neoplasms, intracranial aneurysm, intracranial embolism, intracranial embolism and thrombosis, intracranial thrombosis, invasive ductal breast carcinoma, Kearns-Sayer syndrome, kidney neoplasms, LEOPARD syndrome, leukemia, T-cell leukemia-lymphoma, acute B-cell leukemia, chronic B-cell leukemia, lymphocytic leukemia, acute lymphocytic leukemia, acute L1 lymphocytic leukemia, acute L2 lymphocytic leukemia, chronic lymphocytic leukemia, lymphocytic, acute megakaryocytic leukemia, acute myelocytic leukemia, myeloid leukemia, chronic myeloid leukemia, chronic myelomonocytic leukemia, acute nonlymphocytic leukemia, pre B-cell leukemia, acute promyelocytic leukemia, acute T-cell leukemia, liver disease, liver neoplasms, long QT syndrome, longevity, lung neoplasms, mammary neoplasms, Marfan syndrome, microvascular angina, mitral valve insufficiency, mitral valve prolapse, mitral valve stenosis, myocardial infarction, myocardial ischemia, myocardial reperfusion injury, myocardial stunning, myocarditis, nephritis, hereditary nephritis, ovarian neoplasms, pancreatic neoplasms, prostate neoplasm, chronic obstructive pulmonary disease, pulmonary embolism, pulmonary emphysema, pulmonary heart disease, pulmonary valve stenosis, rectal neoplasms, retinal vein occlusion, rheumatic heart disease, Romano-Ward syndrome, cardiogenic shock, sick sinus syndrome, sigmoid neoplasms, intracranial sinus thrombosis, tachycardia, supraventricular tachycardia, ventricular tachycardia, thromboembolism, thrombophlebitis, thrombosis, torsades de pointes, tricuspid atresia, tricuspid valve insufficiency, and other diseases known to one of ordinary skill in the art. In preferred embodiments, the disease(s) is bladder cancer, lung cancer, breast cancer, and/or pancreatic cancer.

Exemplary candidate genes are those involved in disease, aging-associated diseases, and genes that are involved in genome maintenance and repair. Some examples of candidate genes are apoliprotein E, apolipoprotein C3, microsomal triglyceride transfer protein, cholesteryl ester transfer protein, angiotensin I-converting enzyme, insulin-like growth factor 1 receptor, growth hormone 1, glutathione-S-transferase M1 (GSTM1), catalase, superoxide dismutases 1 and 2, heat shock proteins, paraoxonase 1, interleukin 6, hereditary haemochromatosis, methyenetetrahydrofolate reductase, sirtuin 3, tumor protein p53, transforming growth factor β1, klotho, werner syndrome, mutL homologue 1, mitochondrial mutations (Mt5178A, Mt8414T, Mt3010A and J haplotype), cardiac myosin binding protein C (MYBPC3) as well as other candidate genes involved in longevity known to one of ordinary skill in the art. In preferred embodiments, the candidate gene is glutathione-S-transferase M1 (GSTM1) or cardiac myosin binding protein C (MYBPC3).

### Searching, Retrieving and Filtering of Relevant Literature

Embodiments of the present invention provide tools for automated searching, retrieval and filtering of results from databases, such as PubMed and HuGE. PubMed is an online database of indexed articles, citations and abstracts from medical and life sciences journals maintained by the National Library of Medicine. HuGE (Human Genome Epidemiology) is a searchable knowledge base of genetic associations. HuGE Literature Finder is a continuously updated literature information system that systematically curates and annotates publications on human genome epidemiology, including information on population prevalence of genetic variants, gene-disease associations, gene-gene and gene-environment interactions, and evaluation of genetic tests. In addition to PubMed and HuGE, databases and sources known to one of ordinary skill in the art that contain the appropriate information could also be used.

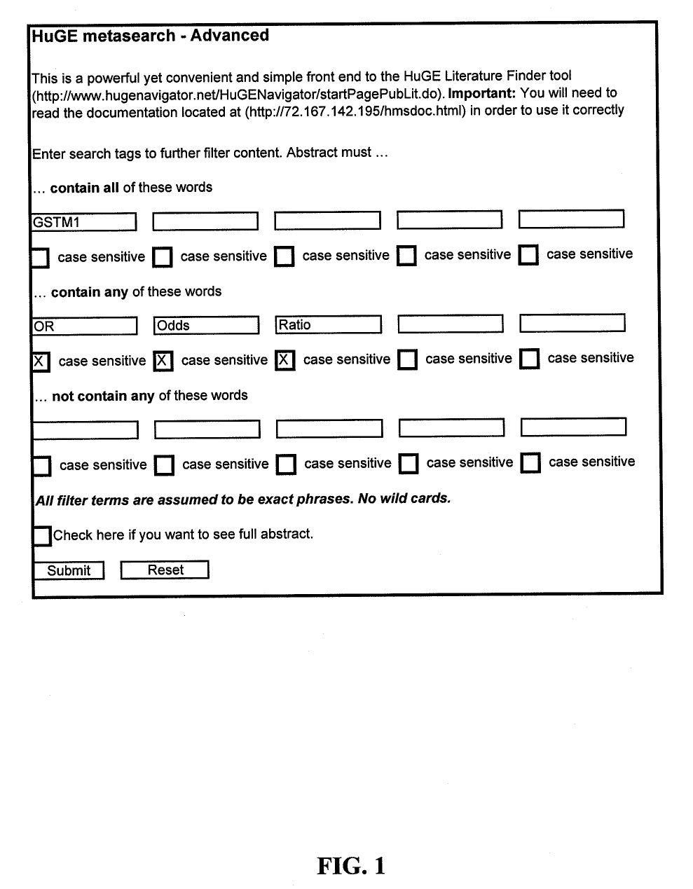

The present invention provides a computer system wherein databases are searched and desired information is collected based on the search parameters entered by the user through an interface. The present invention provides a code for searching the database and selecting relevant articles based on search criteria (e.g., Appendix A illustrates computer system coding for the HuGE metasearch—Advanced software). A user interface as an exemplary search related to GSTM1 is shown in FIG. 1. The additional filters for searching provided in the code and on the interface can allow the user to limit searching to articles that contain or do not contain specific words. For example, Appendix B illustrates the first five results of the search hits identified from running the criteria presented in FIG. 1 through the code in Appendix A.

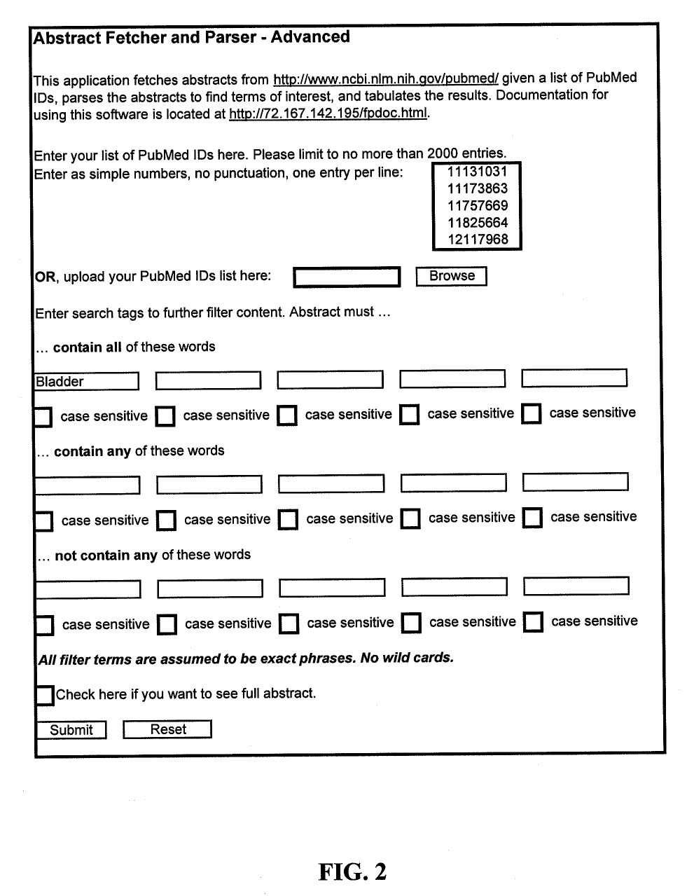

The present invention also provides a computer system wherein abstracts are searched and desired information is collected based on the search parameters entered by the user through an interface. The present invention provides a search code for identifying and parsing the relevant information from abstracts in the literature (e.g., Appendix C illustrates computer system coding for the abstract fetcher-parser software). A user interface as an exemplary search related to bladder cancer with five identified studies (PubMed IDs entered) is shown in FIG. 2. For example, Appendix D shows the results of the search run through the interface of FIG. 2, utilizing the coding of Appendix C.

Embodiments of the present invention also provide search and retrieval tools that permit searching a combination of generic or specific disease terms (e.g., heart disease) and gene symbol (e.g., APOE) on a public resource of choice in an automated fashion. These tools take into account the various ontologically associated disease terms from UMLS (Unified Medical Language System) and MeSH (Medical Subject Headings) vocabulary. For example, the associated terms with “heart disease” can include “coronary aneurysm” and “myocardial stunning”. The search tool can also take into account gene name synonyms or sub-types (e.g., “apolipoprotein E2” and “apolipoprotein E3” as sub-types for the gene symbol “APOE”). This preferred comprehensive approach ensures retrieval of an extensive literature set for the particular disease-gene combination of interest.

Embodiments of the present invention also provide search and retrieval tools that can be used to limit the culled results based on a variety of factors. These factors can include: country or region in which the study was performed or type of study (e.g., genetic association, gene-environment interactions, clinical trial, genome-wide association study and the like). Several publication parameters for each document (such as the title, abstract, PubMed ID, journal, author list and year of publication) can be automatically parsed by these tools. All of this information can be uploaded into the central database apparatus.

Embodiments of the present invention provide a filtering tool that enables searching the titles and abstracts of the retrieved records based on any combination of terms. Several types of terms can be supported by the tool. Exemplary terms are: statistical terms (e.g., odds ratio (OR), hazard ratio (HR), relative risk (RR), p-values, primary statistic, number of cases and controls, adjusting variable, confidence intervals and the like); environmental effect terms (e.g., smoking, exercise, geographic location, language, temperature, altitude, and the like); personal terms (e.g., ethnicity, gender, age distribution of the study population); interaction terms (e.g., gene/gene interaction terms, gene/environment interaction terms); and other general terms (e.g., statistical significance, phenotype description, time of onset, study model used, study approach (classical or Bayesian), endpoints and outcomes such as, accelerated disease progression or sudden death). The filtering tool can also provide for the use of markers such as binary data fields to enter review status information (e.g., indication as to whether the article and the electronic record have been marked for additional review, whether the electronic record of data collected is ready to proceed to upload into the genetic database, and the like)

Boolean logic can be implemented, which allows the user to enter any combination of the above described terms or additional terms known to one of ordinary skill in the art. Case-sensitive searches can be preformed to aid in narrowing the results. The methods of the present invention can be created by systems using a variety of programming languages including but not limited to C, Java, PHP, C++, Perl, Visual Basic, sql and other languages which can be used to cause the computing system of the present invention to perform the steps of the methods described herein.

Curating Data from Literature

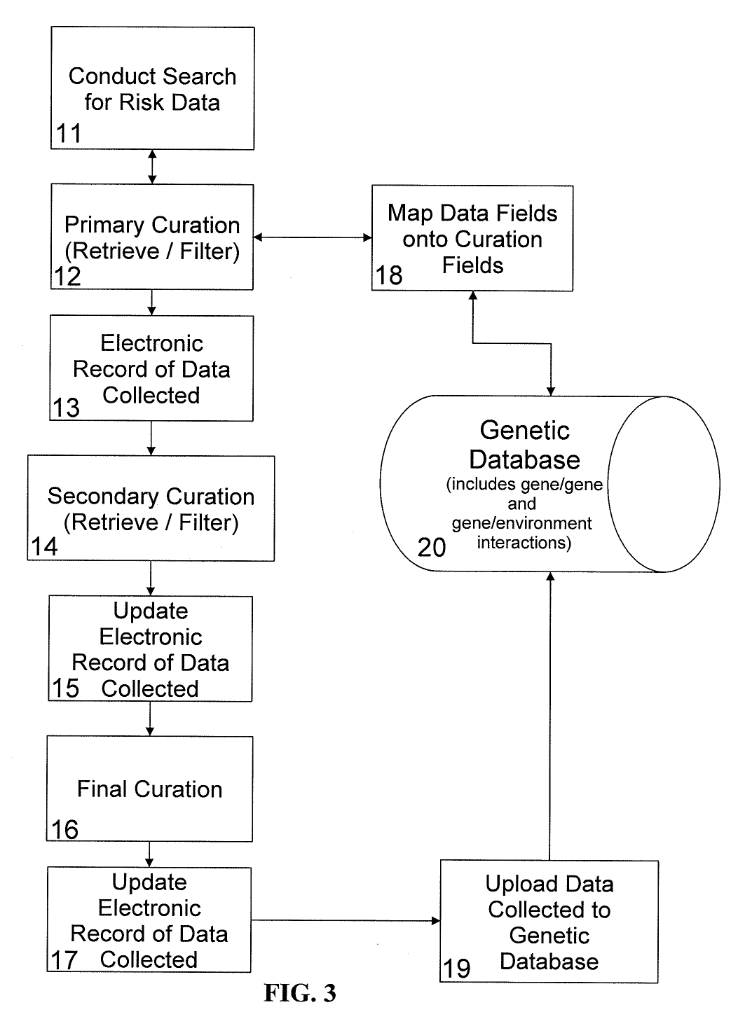

A preferred embodiment of the present invention is shown in FIG. 3, the scientific articles and literature containing risk data (e.g., statistical contributions of genetic attributes related to disease) identified by the exemplary search methods of the present invention (11) can be passed through a primary curation phase (12) where the articles can be retrieved using a retrieval apparatus and filtered by article content prior to collecting the first set of data in an electronic record (13). Upon initiation of primary curation (12), the curation fields can be mapped to the data fields (18) in the genetic database (20). This process can be done iteratively as additional curation fields could be entered into the electronic record of data collected (13, 15, 17). The scientific articles and literature containing risk data can be subject to additional review. A review mechanism can be utilized that marks the article of concern for additional review [shown as secondary curation (14) or final curation (16)]. Without being limited to a specific number of review/curation rounds, the present invention provides for single or multiple rounds of article searching and curation of data. The publications identified and curated can be archived in the genetic database and/or central database apparatus to facilitate quick referencing.

A secondary curation phase (14) can follow the primary curation phase (12) where additional literature and experimental results can be retrieved and the appropriate risk data can be obtained and collected in an electronic record (15). A final curation phase (16) can also follow the secondary curation phase (14) where additional literature and experimental results can be retrieved or the collected data can be reviewed to produce an electronic record of data collected (17) that can be uploaded into the genetic database (19). The genetic database (20) can serve as a central repository for the risk data associated with gene/gene interactions and/or gene/environment interactions.

Deposition of Relevant Data into the Central Database Apparatus

The central database apparatus can be the central location of all the automatically searched, retrieved and filtered literature as well as curated literature. Curated literature and electronic records pending final curation can also be stored in the central database apparatus. A secondary set of tables can store pending results and final results in order to preserve the quality of the final statistical model.

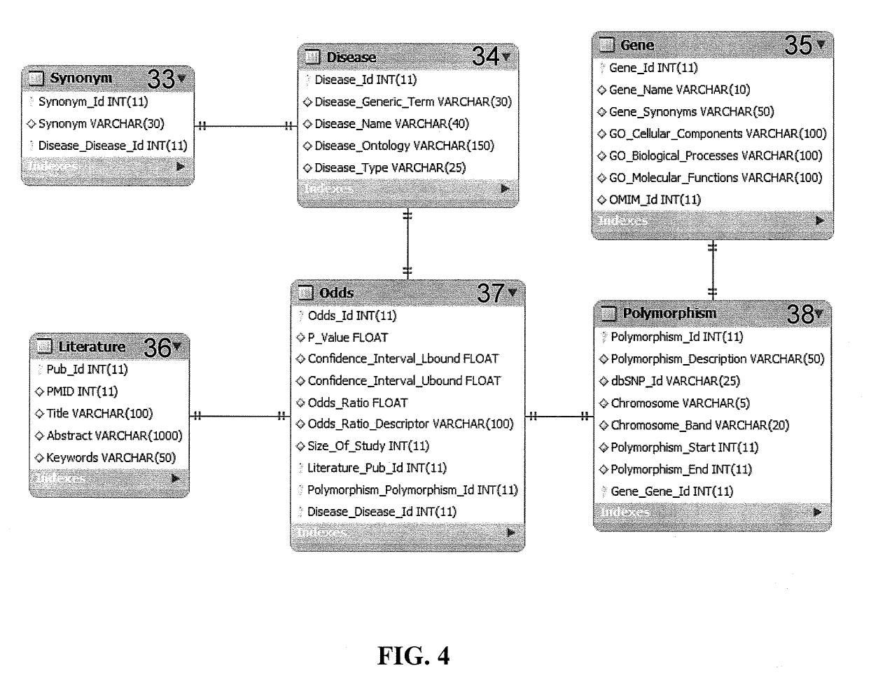

The electronic record of data collected can be stored in tables comprising fields of information related to the genetic markers identified. As shown by example in FIG. 4, the data fields can include various information related to the candidate gene [e.g. synonym names for the candidate genes or disease (33), information related to the disease (34), information related to candidate gene (35), information related to the article/literature searched (36), statistical information (37) and information related to the genetic marker (38)]. The electronic record of data can be stored in a master file after population of the data in the designated fields. For exemplary purposes, a representative GSTM1 field database can be created using the code of Appendix E.

The central database apparatus can also be used to log information associated with the curation process, such as identification of the user, date and time of data upload, and curation status of the publication and electronic record. For security purposes, users of the central database apparatus can be granted different access privileges to the tables and database.

A number of interfaces to the database can be developed by one of ordinary skill in the art to enable easy and intuitive access to the data set of interest. Interfaces can also be developed for direct entry of curation results into the database or uploading of the full text of the article from which the data was collected.

Due to the evolving process of scientific research, newly determined studies in genetic association are being conducted on a regular basis. To address this, the database can have a field that specifies the date when the database was last updated. At periodic intervals, the database can be queried for literature resources for all curated diseases in the database, and new references can be identified that have not been curated and deposited into the electronic record or the central database apparatus. The central database apparatus can then be augmented by these references through the curation process. The new date when this comparative search is performed can be recorded, and all records in the database can be updated to reflect the new curation date.

### Building a Statistical Framework to Integrate the Data (Risk Data)

Hazard ratio (HR), relative risk (RR) and odds ratio (OR) calculations can be used as risk data to determine the statistical contribution of genetic attributes to occurrence of an event (such as disease). In a prospective study, RR is the ratio of the proportion of cases having a pre-defined disease in the exposed group (e.g., those with the genetic variant of interest) over that in the control group (e.g., those without the genetic variant of interest). In a case-control retrospective study, such as GWAS, calculation of the OR is preferred and can be estimated as the ratio of the odds of an event occurring in one group to the odds of it occurring in another group, or the ratio of being exposed to an event for the case group (e.g., those with allele of interest) over that in the control group (e.g., those without the allele of interest).

In one embodiment of the present invention, the relative risk is used. For example, if the number of observations in each exposure/outcome combination is labeled as those shown in Table 1, the calculation of RR is {A/(A+B)}/{C/(C+D)}. In a rare disease/outcome with incidence<10%, A (C) is much smaller than B (D). Therefore, RR can be approximated by {A/B}/{C/D}, which is equal to {A/C}/{B/D}, the OR. However, for more common outcomes, the OR always overstates the RR, sometimes dramatically. Alternative statistical methods can be used for estimating an adjusted RR when the outcome is common (Localio et al. 2007. J Clin Epidemiol. 60(9):874-882; McNutt et al. Am J 2003. Epidemiol. 157(10):940-943; Zhang et al. 1998. Jama. 280(19):1690-1691).

TABLE 1
Parameters for Calculation of OR

| | Outcome positive | Outcome negative |
|---|---|---|
| Exposure | A | B |
| positive | | |
| Exposure | C | D |
| negative | | |

In another embodiment, the hazard ratio is used. The hazard ratio (HR) is the ratio of the hazards of the treatment and control groups at a particular point in time. There is no direct mathematical relationship between the OR and the HR. However, the HR can be approximated by the odds ratio (OR) using a Taylor series expansion assuming disease prevalence is small (Walker. 1985. Appl Statist. 34(1):42-48).

Since the sample size of most genetic-association studies is small to moderate leading to inconsistent results, meta-analysis, that combine multiple studies with similar measures are warranted to evaluate the significance of the genetic associations. Meta-analysis permits the calculation of summary ORs, which are weighted averages of ORs from individual studies. Both Mantel Haenszel and Peto's methods are commonly used by one of skill in the art to estimate such summary ORs in meta-analysis. These methods require 2×2 tables that cannot control for confounding factors.

In addition, it is preferred to select an effect model. Usually the choice is between a fixed effects model, which indicates that the conclusions derived in the meta-analysis are valid for the studies included in the analysis, and a random effects model, which assumes that the studies included in the meta-analysis belong to a random sample of a universe of such studies. When the studies are found to be homogeneous, random and fixed effects models are indistinguishable.

Engels et al. systematically evaluated 125 meta-analysis studies, and concluded that random effects estimates, which incorporate heterogeneity, tended to be less precisely estimated than fixed effects estimates (Stat Med. 2000 Jul. 15; 19(13):1707-28). Furthermore, summary odds ratios and risk differences agreed in statistical significance, leading to similar conclusions about whether treatments affected the outcome. Heterogeneity was common regardless of whether treatment effects were measured by odds ratios or risk differences. However, risk differences usually displayed more heterogeneity than odds ratios.

Meta analysis techniques have been implemented in several statistical software packages, including R (The R Project for Statistical Computing; http://www.r-project.org/). Most of these packages also allow investigators to test studies for heterogeneity and publication bias, which refers to the greater likelihood of research with statistically significant results to be reported in comparison to those with null or non significant results.

In still another embodiment of the present invention, an odds ratio (OR) is used. The OR is the ratio of the odds of an event occurring in one group to the odds of it occurring in another group, or to a sample-based estimate of that ratio. These groups might be men and women, an experimental group and a control group, or any other dichotomous classification (e.g., with and without a specific risk allele). If the probabilities of the event in each of two groups are p (first group) and q (second group), then the OR is expressed by the following formula:

$$\frac{p / ( 1 - p )}{q / ( 1 - q )} = \frac{p ( 1 - q )}{q ( 1 - p )}$$

An OR=1 indicates that the condition or event under study is equally likely in both groups. An OR>1 indicates that the condition or event is more likely in the first group.

In another embodiment, the central database apparatus contains a panel of risk SNPs (SNPs located in risk alleles of candidate genes) with their corresponding ORs for each disease. In an additional embodiment, the central database apparatus also contains a list of ORs for implicated environmental factors and optionally ORs for interactions between SNPs and environmental factors. These ORs can be indicative of how likely a person is to develop a disease given his genetic makeup and environmental factors. The ORs for SNPs and environmental factors can be assumed to be additive within a particular disease.

Receiving Input Data (E.g. Genomic Sequence Including Sequence of Candidate Genes) from an Individual

Genetic information can be collected from an individual by a variety of methods known in the art. In one embodiment collection involves the contribution by the individual of a buccal swab (i.e., inside the cheek), a blood sample, or a contribution of other biological materials containing genetic information for that individual. The genetic sequence can be determined by known methods such as that disclosed in Stephan et al., US 2008/0131887, incorporated in its entirety by reference, as well as methods employed by companies such as SeqWright, GenScript, GenoMex, Illumina, ABI, 454 Life Sciences, Helicos and additional methods known to persons of ordinary skill in the art.

### Calculation of Disease Susceptibility, Fatality Scores and GPLE

From the central database apparatus, data can be extracted to calculate statistical parameters such as an individual's ORs of disease susceptibility based on the specific SNPs that individual possesses. These ORs can be used to calculate fatality scores. Curated ORs from a wide range of high mortality diseases along with fatality scores for the diseases can be generated in the central database apparatus. The fatality score can qualitatively take into account several relevant factors such as mortality, average age of disease manifestation and prevalence within the population. The list of fatality scores can be customizable based on user or external third party databases results and preferences, and can reflect results from external databases results about the relative importance of the diseases in predicting mortality.

The ORs calculated by the meta-analysis approach of the method provided by the present invention can be used as weights for the fatality scores to calculate an overall life expectancy for an individual given his/her genotype (i.e. GPLE). The GPLE is an individual age-specific probability for living an additional number of years given that individuals genetic profile (i.e. genomic DNA sequence) for the candidate genes of interest. This GPLE will be strongly indicative of mortality, with higher values corresponding to individuals at greater risk of contracting or succumbing to a high mortality disease. As more GWAS are completed, more gene/gene and gene/environment interaction ORs can be reported and calculated and as next-generation sequencing technologies are widely adapted these calculations will increase in precision.

In one embodiment, the methods of the present invention can be utilized to provide survivorship data for people with specific risk genotype patterns. For these individuals, a panel of risk alleles in candidate genes can be identified in the electronic record of data collected. Individuals with a specific combination of these risk alleles can be monitored until their death in order to provide actual mortality data for the particular risk alleles of these candidate genes and more accurately determine life expectancy. Many GWAS are based on case-control design to identify risk alleles associated with certain diseases or traits. With actual mortality data for individuals with known genetic profiles, the methods of the present invention provide a database that can be populated with actual mortality data, resulting in an additional sample population to utilize in calculating probabilities and predicted genetic life expectancy for individuals with these risk alleles. This can provide more precise estimates and life tables (also called mortality tables or actuarial tables) based on genetic profiles.

In another embodiment, the genetic information from the deceased individuals can be used to calculate mortality rates and/or life expectancies for those carrying specific risk alleles of candidate genes. Life tables show the probability of surviving until the next year for someone of a given age. Classification of the data in life tables is subdivided by gender, personal habits, economic condition, ethnicity, medical conditions and other factors attributable to life expectancy. There are multiple sources for mortality tables, such as The Society of Actuaries, National Center for Health Statistics (NCHS), CDC, and others known to a person of ordinary skill in the art. Life tables can provide basic statistical data for deaths and diagnosed cause of death correlated with personal factors (e.g., sex, race, lifestyle habits, social habits, education, and the like) and mortality. See National Vital Statistics Report. CDC. 56(10):1-124.

Life expectancy is the average number of years of life remaining at a given age. The starting point for calculating life expectancies is the age-specific death rates of the population members. For example, if 10% of a group of people alive at their 90th birthday die before their 91st birthday, then the age-specific death rate at age 90 would be 10%.

These values can be used to calculate a life table, which can be used to calculate the probability of surviving to each age. In actuarial notation, the probability of surviving from age x to age x+n is denoted ₙpₓ and the probability of dying during age x (i.e. between ages x and x+1) is denoted qₓ.

The life expectancy at age x, denoted eₓ, is then calculated by adding up the probabilities to survive to every age. This is the expected number of complete years lived:

$${e}_{x} = {\sum }_{t = 1}^{∞} {}_{t}^{}{p}{}_{x}^{} = {\sum }_{t = 0}^{∞} t {}_{t}^{}{p}{}_{x}^{} {q}_{x + t}$$

Because age is rounded down to the last birthday, on average people live half a year beyond their final birthday, so half a year is added to the life expectancy to calculate the full life expectancy.

Life expectancy is by definition an arithmetic mean. It can be calculated also by integrating the survival curve from ages 0 to positive infinity. For an extinct population of individuals, life expectancy can be calculated by averaging the ages at death. For a population of individuals with some survivors it is estimated by using mortality experience in recent years.

Using this life expectancy calculation, no allowance has been made for expected changes in life expectancy in the future. Usually when life expectancy figures are quoted, they have been calculated in this manner with no allowance for expected future changes. This means that quoted life expectancy figures are not generally appropriate for calculating how long any given individual of a particular age is expected to live, as they effectively assume that current death rates will be “frozen” and not change in the future. Instead, life expectancy figures can be thought of as a useful statistic to summarize the current health status of a population. Some models do exist to account for the evolution of mortality (e.g., the Lee-Carter model) (R. D. Lee and L. Carter 1992. J. Amer. Stat. Assoc. 87:659-671) and can be used in the embodiments of the invention.

Given the age, gender, race (AGR) of a person, the median life expectancy of the person can be calculated from mortality tables. Life expectancy calculations, in general, are heavily dependent on the criteria used to select the members of the population from which it is calculated. The baseline life expectancy (BLE) can be defined as the median life expectancy of individuals with matched AGR parameters.

The inclusion of information on additional parameters such as medical factors (e.g., disease, stage of disease, treatment regimen, medical history and the like), environmental factors (e.g., exercise, smoking, occupational exposure and the like) and extended demographic information (e.g., geographical region, socioeconomic status and the like) can substantially enhance the life expectancy estimate for an individual. The specific life expectancy (SLE) of an individual for a given disease can be defined as the median life expectancy of individuals affected with that disease, with matched demographic, medical and environmental parameters. The specificity of the SLE for an individual for a given disease can depend on the availability of detail in the literature.

The present invention provides a method for improved calculation of life expectancy based on genetic profiles, resulting in a GPLE. The inclusion of genetic information for an individual, such as SNPs, can increase the accuracy of life expectancy estimates. The GPLE is the median life expectancy of individuals with matched genetic profiles for individual candidate genes. In addition, calculation of GPLE by the methods herein, utilizes a central database apparatus under constant evolvement, continually factoring in the newest developments in genetic association scientific research reported in the literature.

In preferred embodiments, the GPLE for an individual can be calculated from a blended approach, a minimum approach or any other approach known to one of ordinary skill in the art (in cases where the SLEs are not available, BLEs can be used). An example of a blended approach for three diseases is shown below. This approach calculates GPLE based on a combination of SLEs for three diseases (i₁, i₂, i₃), where all the corresponding OR(i) values contribute to the GPLE:

$$= \frac{OR ( {i}_{1} ) \cdot SLE ( {i}_{1} ) + OR ( {i}_{2} ) \cdot SLE ( {i}_{2} ) + OR ( {i}_{3} ) \cdot SLE ( {i}_{3} )}{OR ( {i}_{1} ) + OR ( {i}_{2} ) + OR ( {i}_{3} )}$$

An example of a minimum approach for three diseases is shown below. This approach calculates GPLE based on the minimum of scaled SLEs for the diseases, where the scale factor for a corresponding OR(i) value is dependent on age and gender:

$$= min \{ \frac{SLE ( {i}_{1} )}{\sqrt[p]{OR ( {i}_{1} )}} , \frac{SLE ( {i}_{2} )}{\sqrt[p]{OR ( {i}_{2} )}} , \frac{SLE ( {i}_{3} )}{\sqrt[p]{OR ( {i}_{3} )}} \}$$

The advantages of the GPLE calculation methods of the present invention above are twofold: 1) they combine a measure of the likelihood of an individual developing a disease (OR(i)) with the life expectancy of the individual with the genetic markers for that disease (reflected in the GPLE) and 2) a numerical value is provided that is indicative of the life expectancy of a person taking into account multiple input data or parameters, such as genetic, medical, environmental, demographic parameters.

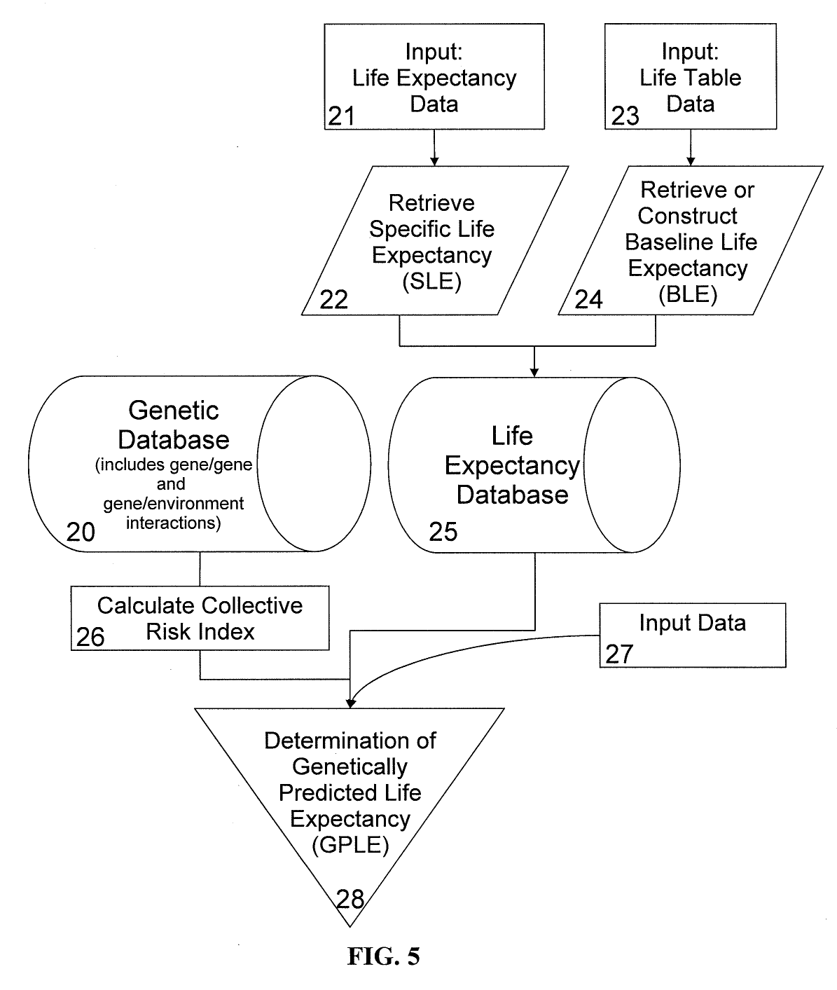

A preferred embodiment of the present invention is shown in FIG. 5. The determination of GPLE (28) can be based on information contained in a genetic database (20) and a life expectancy database (25). The genetic database can be comprised of information as discussed in FIG. 3. The life expectancy database (25) can contain information related to life expectancy data (21) and life table data (23). The retrieval of a specific life expectancy (22) from reported life expectancy data and the retrieval or construct of a baseline life expectancy (23) from reported life table data can be collectively housed in the life expectancy database (25). To determine GPLE, a user can calculate a collective risk index (26) based on multiple genetic factors and, along with the input data (27) from an individual, calculate a GPLE (28). The calculated GPLE can take into account individual or multiple genetic markers affiliated with disease susceptibility and longevity.

### Determination of Life Insurance Policy Value Based on GPLE

The resultant GPLE can be utilized in the evaluation of life insurance policies. The GPLE can be inserted into standard time value of money equations, such as Present Value, Future Value, IRR and Net Present Value methods to calculate the theoretical value of a policy given the resultant life expectancy based on the genetic disposition of the insured. The GPLE can be used as a time interval in any standard financial valuation equation that calls for discounting or accruing in the analysis of life insurance products.

Time value of money approaches can discount an amount of funds in the future to determine their worth at a prior period, generally the present. This technique is applied to both lump sums and streams of cash flow. Adjustments in the calculations can be made for whether the cash flow takes place at the beginning or the end of the period. Additional mathematical adjustments may also be made to adjust for certain policy features, such as minimum guaranteed returns, compounding periods and the like.

The present value vₙ of a single payment made at n periods in the future is

$${v}_{n} = \frac{p}{{( 1 + r )}^{n}} . \qquad ( 1 )$$

where n is the number of periods until payment, p is the payment amount, and r is the periodic discount rate. The present value v_{∞} of equal payments made each successive period in perpetuity (a.k.a. the present value of a perpetuity) is given by

$${v}_{∞} = {\sum }_{n = 1}^{∞} \frac{p}{{( 1 + r )}^{n}} = \frac{p}{r} . \qquad ( 2 )$$

The present value v′ of equal payments made each successive period for n periods (i.e. the present value of an annuity) is given by

$${v}^{′} = {v}_{- ∞} - {v}_{n} = \frac{p}{r} [ 1 - \frac{1}{{( 1 + r )}^{n}} ] , \qquad ( 3 )$$

where p is the periodic payment amount.

In applying the GPLE to value a policy, the GPLE can be used to project the date of death by adding the GPLE, which is essentially a time interval to the current date. The GPLE would represent the time interval in the future that the insured would be projected to expire, thereby generating a payment inflow of the face value of the policy at that date in the future. In order to calculate the theoretical value of the policy, the life insurance face value or policy proceeds would be discounted back from that projected future date to the present using either a market or required interest rate. In addition, the present value of the future stream of cash outlays representing the periodic premium payments required to keep the policy in force would be deducted from the present value of the policy proceeds received.

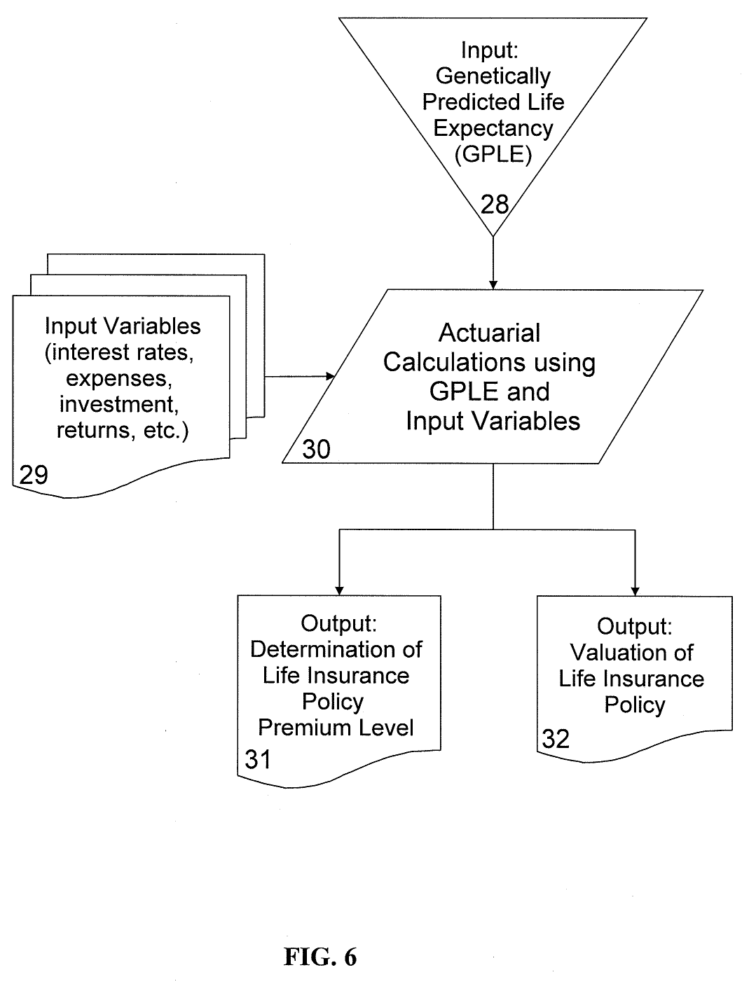

A preferred embodiment of the present invention is shown in FIG. 6. The evaluation of a life insurance policy can be conducted using input from the GPLE (28) and from external input variables (e.g., interest rates, expenses, investments, returns, and the like) (29). The input conditions (27 and 28) can be used in actuarial calculations to determine a value for the life insurance policy as an asset (32) or to determine the value for the policy premium of a life insurance policy for an individual (31).

### Example 1

### Calculation of OR(Disease) for an Individual with GSTM1 Null Genotype

For example, an OR for bladder cancer can be determined. To calculate the odds ratio, thirty-one population-based case-control studies were curated from PubMed to investigate the risk of bladder cancer associated with glutathione-S-transferase M1 (GSTM1) null genotype. To avoid confounding by ethnicity, five Caucasian-based studies were used, which included 896 cases and 1,241 controls. Odds ratios from these five individual studies range from 1.15 to 2.2 (Arch. Toxicol. 2000 74(9):521-6, Cytogen. Cell. Gen. 2000 91(1-4):234-8, Int. J. Cancer 2004 110(4):598-604, Cancer Lett. 2005 219(1):63-9, Carcinogenesis 2005 26(7):1263-71). The summary OR calculated using the Mantel-Haenszel method was 1.37 (95% CI [1.15, 1.64]) for the fixed effect model and 1.56 (95% CI [1.12, 1.91]) for the random effect model. This result also showed no significant heterogeneity in study outcomes among these five studies (p=0.08). The OR estimate from this analysis is similar to the summary OR from a meta-analysis conducted by Engel et al. that included seventeen individual studies (OR=1.44; 95% CI [1.23, 1.68]; 2,149 cases and 3,646 controls).

### Example 2

### Calculation of OR(Disease) for Lung Cancer, Breast Cancer and Pancreatic Cancer

Assuming a list of three diseases (wherein for disease i, let OR(i) represent the cumulative additive effect of all relevant ORs for a given person): lung cancer (lung), breast cancer (breast) and pancreatic cancer (pancreatic), and each with ten known SNPs. For the example below, the following assumptions can be made; each SNP has an OR of 1.2. Environmental effect of smoking has an OR of 1.5 for lung cancer in general, and 1.6 when found in combination with SNP 1 for lung cancer. The OR of smoking for breast and pancreatic cancer is not known.

For a given person, their SLE can be estimated for lung, breast and pancreatic cancer from the best matched life expectancy or life table data from literature, for example:

SLE(lung)=1.5 years, SLE(breast)=10 years, SLE(pancreatic)=1 year

The OR(lung) for a given person can be calculated as follows based on the different scenarios:

If an individual has SNPs 2-10, but not SNP 1, and is a non-smoker, the OR(lung) can be calculated as follows: OR(lung)=(1.2−1)*9+1=2.8

If an individual has SNPs 1-10, and is a non-smoker, the OR(lung) can be calculated as follows: OR(lung)=(1.2−1)*10+1=3

If an individual has SNPs 1-10, and is a smoker, the OR(lung) can be calculated as follows: OR(lung)=(1.2−1)*10+(0.6)+1=3.6

If an individual has SNPs 2-10, and is a smoker, the OR(lung) can be calculated as follows: OR(lung)=(1.2−1)*9+(0.5)+1=3.3

Similar to the OR(lung) calculations above, the OR(breast) and OR(pancreatic) can be similarly calculated to be OR(breast)=0.5 and OR(pancreatic)=1.2

### Example 3

### Calculation of GPLE for an Individual with SNPs 1-10 Who is a Smoker Using a Blended Approach.

The GPLE for the individual in Example 2 can be calculated using a blended approach that does not prioritize one disease over another. This type of approach evaluates the diseases in combination and provides for an overall perspective. The blended approach can be calculated as follows:

$$= \frac{\begin{matrix}OR ( lung ) \cdot SLE ( lung ) + OR ( breast ) \cdot SLE ( breast ) + \\ OR ( pancreatic ) \cdot SLE ( pancreatic )\end{matrix}}{OR ( lung ) + OR ( breast ) + OR ( pancreatic )} \\ = \frac{3.4 \cdot 1.5 + 0.5 \cdot 10 + 1.2 \cdot 1}{3.4 + 0.5 + 1.2} \\ = 2.22$$

### Example 4

### Calculation of GPLE for an Individual with SNPs 1-10 Who is a Smoker Using a Minimum Approach

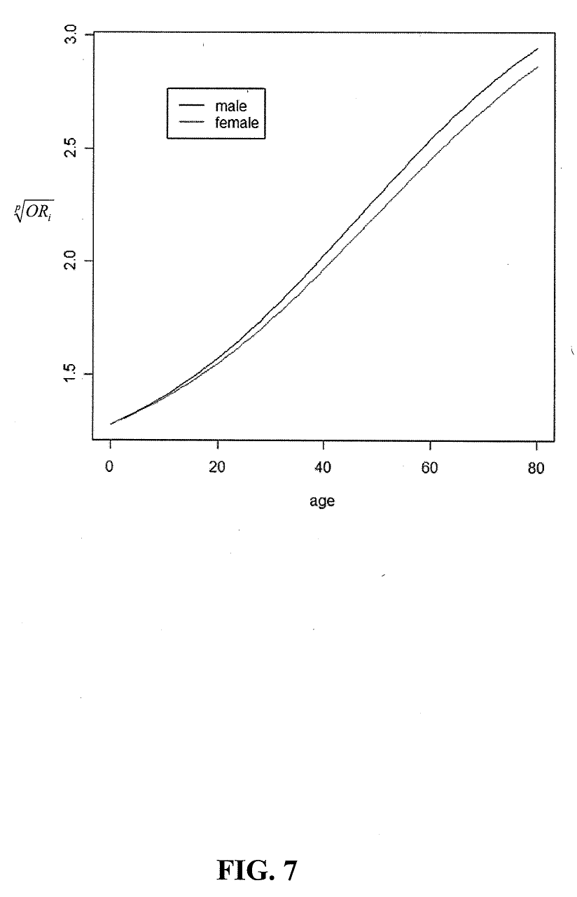

The GPLE for the individual in Example 2 can also be calculated using a minimum approach that factors in age and sex, resulting in a GPLE generated by the disease with the greatest contribution. The minimum approach can be calculated as follows:

$$min \{ \frac{SLE ( lung )}{\sqrt[p]{OR ( lung )}} , \frac{SLE ( breast )}{\sqrt[p]{OR ( breast )}} , \frac{SLE ( pancreatic )}{\sqrt[p]{OR ( pancreatic )}} \}$$

where p is a function of age and sex. Specifically, p=1+α·exp(−β·age/λₛₑₓ) α, β>0. Note that p is a monotonic decrease function of age, and α and β are two tuning parameters that can be determined by the mortality table. λₛₑₓ is a constant factor for sex, which is also determined by mortality table. λₛₑₓ=1 for female if OR(disease)>1; otherwise, λₛₑₓ=1 for male. If α=4, β= 1/25, and λₛₑₓ=0.94, using the equation above, a GPLE minimum of (3.97, 17.50, 6.13), which is 3.97 for a male and min (4.12, 17.62, 6.16)=4.12 for a female is generated. FIG. 7 illustrates a survival curve representing the relation between p\sqrt{OR(lung)} and age/sex.

### Example 5

### Calculation of GPLE for an Individual with a High Risk Genetic Mutation

A high prevalence of mutation (4%, deletion of 25 bp) in the gene encoding cardiac myosin binding protein C (MYBPC3) is associated with high risk of heart failure (OR=7) [Dhandapany P S et al. (2009). A common MYBPC3 (cardiac myosin binding protein C) variant associated with cardiomyopathies in South Asia. Nat Genet. 41(2):187-91.]. Assuming SLE is 15 for individuals at age 55. If α=8, β= 1/30, and λₛₑₓ=0.9, applying the minimum approach for life expectancy calculation, the GPLE is 5.8 for men and 6.4 for women with this gene mutation, e.g, 38% or 42% of SLE. Similarly, if SLE is 25 for individuals at age 45, the GPLE is 11.5 for men and 12.4 for women (46% or 50% of SLE).

### Example 6

### Determination of Life Insurance Policy Value Based on Fatality Score

In continuation of the individual presented in Example 4 (the male, age 55 who has a mutation for the gene encoding cardiac myosin binding protein C (MYBPC3) and has a fatality score of 5.8), the calculations below assume the insured has a policy that has a face value of $1,000,000 and has monthly premiums due of $1000 a month to keep the policy in force. In addition, annual interest rate of 6% is assumed.

The life expectancy fatality score of 5.8 can be converted into 69.6 months.

Applying the formula for Present Value results in the present value of the policy proceeds would be $706,711.41.

From this we must subtract the Present Value of the 69.6 payments which equals −$58,657.72 as the total cost in present value terms of the 69.6 payments.

Therefore the theoretical value of this policy assuming an interest rate of 6% is $706,711.41−$58,657.72=$648,053.69.

1. A method for using a central database apparatus to evaluate a life insurance policy for a member of a population, the central database apparatus comprising a genetic database and a life expectancy database, and the method comprising the steps of:
a) identifying at least one candidate gene;
b) using a retrieval apparatus adapted to retrieve literature to collect literature containing risk data relating to the candidate gene and life expectancy data;
c) uploading the risk data from the collected literature into the genetic database;
d) uploading the life expectancy data from the collected literature into the life expectancy database;
e) using a computer to calculate a collective risk index based on the uploaded risk data and the uploaded life expectancy data;
f) collecting input data from the population member;
g) using the collected input data and the calculated collective risk index to determine a genetically predicted life expectancy (GPLE) for the member; and
h) evaluating the life insurance policy based on the GPLE.

2. A method of claim 1, wherein the collective risk index comprises a meta-analysis odds ratio.

3. A method of claim 1, wherein collecting input data further comprises collecting a biological sample from the member, wherein the biological sample contains genomic DNA.

4. A method of claim 3, further comprising isolating a genomic DNA sequence for the member from the biological sample.

5. A method of claim 4 wherein the candidate gene is contained in the genomic DNA sequence.

6. A method of claim 1, wherein the input data comprises at least one selected from the group consisting of: genetic markers, medical history, personal habits, exercise habits, dietary habits, health habits, social habits, occupational exposure and environmental exposure.

7. A method of claim 1, wherein the input data comprises genetic markers and at least one selected from the group consisting of: medical history, personal habits, exercise habits, dietary habits, health habits, social habits, occupational exposure and environmental exposure.

8. A method of claim 6 or 7, wherein the medical history comprises information related to at least one selected from the group consisting of: a manifested disease, a disorder, a pathological condition and a genomic DNA sequence.

9. A method of claim 1, wherein input data comprises genetic markers.

10. A method of claim 9, wherein the genetic markers comprise at least one selected from the group consisting of: a DNA point mutation, a DNA frame-shift mutation, a DNA deletion, a DNA insertion, a DNA inversion, a DNA expression mutation, and a DNA chemical modification.

11. A method of claim 10, wherein the DNA point mutation comprises a single nucleotide polymorphisms.

12. A method of claim 1, wherein the central database apparatus is iteratively updated with additional risk data and life expectancy data.

13. A method of claim 1, wherein evaluating the life insurance policy comprises determining policy premium amounts.

14. A method of claim 1, wherein the life insurance policy is categorized based on the GPLE.

15. A system for evaluating a life insurance policy for a member of a population, the system comprising a computer server and a central database apparatus, the central database apparatus comprising a genetic database and a life expectancy database, and the server being configured to:
a) prompt a user to identify at least one candidate gene;
b) prompt the user to collect literature containing risk data relating to the at least one candidate gene and life expectancy data;
c) upload the risk data from the collected literature into the genetic database;
d) upload the life expectancy data from the collected literature into the life expectancy database;
e) calculate a collective risk index based on the uploaded risk data and the uploaded life expectancy data;
f) prompt the user to provide input data relating to the population member;
g) use the provided input data and the calculated collective risk index to determine a genetically predicted life expectancy (GPLE) for the member; and
h) evaluate the life insurance policy based on the determined GPLE.

16. A system of claim 15, wherein the collective risk index comprises a meta-analysis odds ratio.

17. A system of claim 15, wherein the input data comprises collecting a biological sample from the population member, wherein the biological sample contains genomic DNA.

18. A system of claim 17, further comprising isolating a genomic DNA sequence for the population member from the biological sample.

19. A system of claim 15, wherein the candidate gene is contained in the genomic DNA sequence.

20. A system of claim 15, wherein the input data comprises at least one selected from the group consisting of: genetic markers, medical history, personal habits, exercise habits, dietary habits, health habits, social habits, occupational exposure and environmental exposure.

21. A system of claim 15, wherein the input data comprises genetic markers and at least one selected from the group consisting of: medical history, personal habits, exercise habits, dietary habits, health habits, social habits, occupational exposure and environmental exposure.

22. A system of claim 20 or 21, wherein the medical history comprises information related to at least one selected from the group consisting of: a manifested disease, a disorder, a pathological condition and a genomic DNA sequence.

23. A system of claim 15, wherein the input data comprises genetic markers.

24. A system of claim 23, wherein the genetic markers comprise at least one selected from the group consisting of: a DNA point mutation, a DNA frame-shift mutation, a DNA deletion, a DNA insertion, a DNA inversion, a DNA expression mutation, and a DNA chemical modification.

25. A system of claim 23, wherein the DNA point mutation comprises a single nucleotide polymorphism.

26. A system of claim 23, wherein the central database apparatus is iteratively updated with additional risk data and life expectancy data.

27. A system of claim 23, wherein evaluation of the life insurance policy comprises determination of policy premium levels.
